(19) United States
(12) Patent Application Publication
(10) Pub. No.: US 2025/0360709 A1
(43) Pub. Date: Nov. 27, 2025

(54) DROPLET EJECTING APPARATUS, CONTROL METHOD OF THE SAME, AND MEDIUM

(71) Applicant: BROTHER KOGYO KABUSHIKI KAISHA, Nagoya (JP)

(72) Inventor: Akira MINAMI, Nagoya (JP)

(73) Assignee: BROTHER KOGYO KABUSHIKI KAISHA, Nagoya (JP)

(21) Appl. No.: 19/186,333

(22) Filed: Apr. 22, 2025

(30) Foreign Application Priority Data
May 21, 2024 (JP) 2024-082768

(51) Int. Cl. B41J 2/045; B41J 2/21; B41J 25/00

(52) U.S. Cl. CPC B41J 2/04593; B41J 2/04541; B41J 2/04573; B41J 2/04581; B41J 2/04588; B41J 2/04591; B41J 2/2103; B41J 25/001

(57) ABSTRACT

There is provided a droplet ejecting apparatus including: a head having a nozzle, a channel, and an actuator; a driving circuit; a mover; and a controller. The controller is configured to execute a moving process of causing the mover to move the head and the recording medium, and an ejecting process of causing the driving circuit to supply a driving signal to the actuator. The driving signal includes a first driving signal to cause the actuator to eject the droplet of a first volume, and a second driving signal to cause the actuator to eject the droplet of a second volume different from the first volume, a resolution of the second driving signal being higher than a resolution of the first driving signal. The controller is configured to, in the ejecting process based on one recording instruction, cause the driving circuit to supply the first or second driving signal.

### REFERENCE TO RELATED APPLICATIONS

This application claims priority from Japanese Patent Application No. 2024-082768 filed on May 21, 2024. The entire content of the priority application is incorporated herein by reference.

### BACKGROUND ART

In the known technique, the moving speed of a carriage is slowed down in some cases to increase the resolution in a carriage-moving direction, and such a necessity is known that the type of moving speed is to be increased to realize a plurality of resolutions. In order to realize the plurality of resolutions without increasing the type of moving speed, such a technique is also known that the moving speeds are set to be the same as each other and the driving waveforms are set to be different from each other among a plurality of print modes respectively executing printings of the plurality of resolutions, droplet volumes being different from each other among the plurality of resolutions.

### SUMMARY

According to the above-described technique, the moving speed is not required to slow down, and thus the high-speed recording can be achieved, and the high resolution of the recording can also be achieved. However, the resolution and the volume of droplet differ for each of the print modes, and thus two or more kinds of resolutions cannot be mixed in a single print mode. Therefore, the improvement in the gradation cannot be achieved.

An object of the present disclosure is to provide a droplet ejecting apparatus, a control method of the droplet ejecting apparatus, and a medium, each of which can achieve a high-speed recording and a high resolution recording, as well as improvement in gradation.

According to a first aspect of the present disclosure, there is provided a droplet ejecting apparatus including:
a head having a nozzle, a channel communicating with the nozzle, and an actuator configured to apply pressure to a liquid in the channel;
a driving circuit configured to supply a driving signal to the actuator;
a mover configured to move the head and a recording medium relative to each other along a moving direction; and
a controller.

The controller is configured to execute a moving process of causing the mover to move the head and the recording medium relative to each other, and an ejecting process of causing the driving circuit to supply the driving signal to the actuator to cause the actuator to eject a droplet of the liquid from the nozzle.

The driving signal includes a first driving signal configured to cause the actuator to eject the droplet of a first volume, and a second driving signal configured to cause the actuator to eject the droplet of a second volume different from the first volume, a resolution in the moving direction of the second driving signal being higher than a resolution in the moving direction of the first driving signal.

The controller is configured to, in the ejecting process based on one recording instruction, cause the driving circuit to selectively supply the first driving signal or the second driving signal to the actuator.

According to a second aspect of the present disclosure, there is provided a control method of a droplet ejecting apparatus, the droplet ejecting apparatus including:
a head having a nozzle, a channel communicating with the nozzle, and an actuator configured to apply pressure to a liquid in the channel;
a driving circuit configured to supply a driving signal to the actuator; and
a mover configured to move the head and a recording medium relative to each other along a moving direction.

The control method comprising:
causing the mover to move the head and the recording medium relative to each other; and
causing the driving circuit to supply the driving signal to the actuator to cause the actuator to eject a droplet of the liquid from the nozzle.

The driving signal includes a first driving signal configured to cause the actuator to eject the droplet of a first volume, and a second driving signal configured to cause the actuator to eject the droplet of a second volume different from the first volume, a resolution in the moving direction of the second driving signal being higher than a resolution in the moving direction of the first driving signal.

The control method comprises, in causing the driving circuit to supply the driving signal to the actuator based on one recording instruction, causing the driving circuit to selectively supply the first driving signal or the second driving signal to the actuator.

According to a third aspect of the present disclosure, there is provided a non-transitory and computer-readable medium storing a program executable by a controller for a droplet ejecting apparatus, the droplet ejecting apparatus including:
a head having a nozzle, a channel communicating with the nozzle, and an actuator configured to apply pressure to a liquid in the channel;
a driving circuit configured to supply a driving signal to the actuator; and
a mover configured to move the head and a recording medium relative to each other along a moving direction.

The program is configured to cause the controller to execute:
causing the mover to move the head and the recording medium relative to each other; and
causing the driving circuit to supply the driving signal to the actuator to cause the actuator to eject a droplet of the liquid from the nozzle.

The driving signal includes a first driving signal configured to cause the actuator to eject the droplet of a first volume, and a second driving signal configured to cause the actuator to eject the droplet of a second volume different from the first volume, a resolution in the moving direction of the second driving signal being higher than a resolution in the moving direction of the first driving signal.

The program is configured to cause the controller to, in causing the driving circuit to supply the driving signal to the actuator based on one recording instruction, cause the driving circuit to selectively supply the first driving signal or the second driving signal to the actuator.

### BRIEF DESCRIPTION OF DRAWINGS

FIG. 1 is a plan view of a printer 10.

FIG. 2 is a cross-sectional view of a head 1 included in the printer 10.

FIG. 3A and FIG. 3B are each a cross-sectional view along a III-III line of FIG. 2.

FIG. 4 is a block diagram depicting the electrical configuration of the printer 10.

FIG. 5 is a flowchart depicting a program executed by a CPU 71 of the printer 10.

FIG. 6 is a schematic view for describing a scanning process.

FIG. 7 is a schematic view depicting a small droplet D1, a medium droplet D2, and a large droplet D3 of an ink droplet ejected from a nozzle.

The lower part of FIG. 8 is a graph depicting a first waveform signal X of a driving signal for small droplet. The upper part of FIG. 8 is a graph depicting a change in the position of meniscus accompanying the supply of the first waveform signal X.

The lower part of FIG. 9 is a graph depicting a second waveform signal Y of the driving signal for small droplet. The upper part of FIG. 9 is a graph depicting a change in the position of meniscus accompanying the supply of the second waveform signal Y.

The lower part of FIG. 10 is a graph depicting a third waveform signal Z of a driving signal for small droplet. The upper part of FIG. 10 is a graph depicting a change in the position of meniscus accompanying the supply of the third waveform signal Z.

### DESCRIPTION

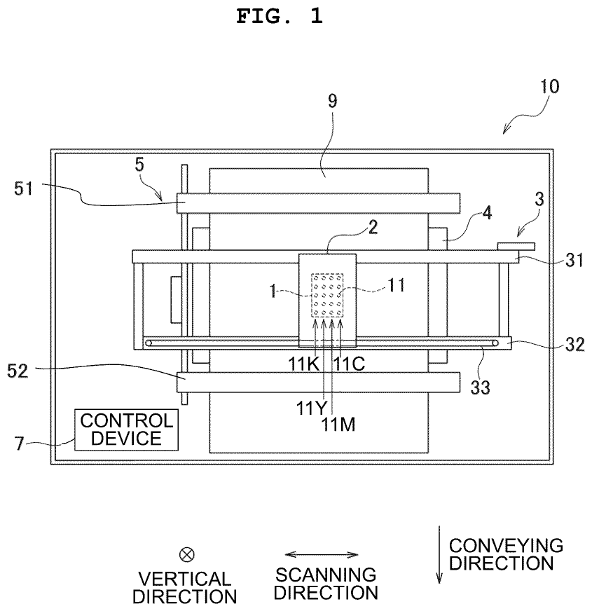

A printer 10 depicted in FIG. 1 is an example of a “droplet ejecting apparatus”. The printer 10 includes a head 1 having a plurality of nozzles 11 in the lower surface of the head 1, a carriage 2 which holds the head 1, a scanning mechanism 3 which moves the carriage 2 in a scanning direction, a platen 4 which supports a sheet 9 from below, a conveying mechanism 5 which conveys the sheet 9 in a conveying direction, and a control device 7. The sheet 9 is an example of a “recording medium”. The scanning mechanism 3 is an example of a “mover (moving mechanism)”. The scanning direction, the conveying direction, and the vertical direction are orthogonal to one another.

The plurality of nozzles 11 constructs four nozzle rows 11C, 11M, 11Y and 11K. The four nozzle rows 11C, 11M, 11Y and 11K are each constructed of nozzles 11 included in the plurality of nozzles and aligned in the conveying direction; the four nozzle rows 11C, 11M, 11Y and 11K are disposed side by side in the scanning direction. The nozzles 11 constructing the nozzle row 11C eject a cyan ink, the nozzles 11 constructing the nozzle row 11M eject a magenta ink, the nozzles 11 constructing the nozzle row 11Y eject a yellow ink, and the nozzles 11 constructing the nozzle row 11K eject a black ink.

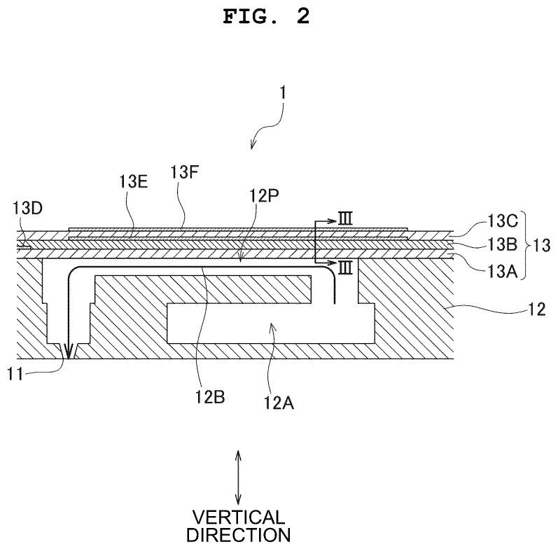

Any one of the cyan, magenta, yellow, and black is an example of a “first color”, and any one of the cyan, magenta, yellow, and black different from the first color is an example of a “second color”. Each of the nozzles 11 constructing any one of the nozzle rows 11C, 11M, 11Y and 11K is an example of a “first nozzle”, and each of the nozzles 11 constructing any one of the nozzle rows 11C, 11M, 11Y and 11K different from the first row is an example of a “second nozzle”. Further, among a plurality of pressure chambers 12P (see FIG. 2) which will be described later, a pressure chamber 12P communicating with the first nozzle is an example of a “first channel”, and a pressure chamber 12P communicating with the second nozzle is an example of a “second channel”.

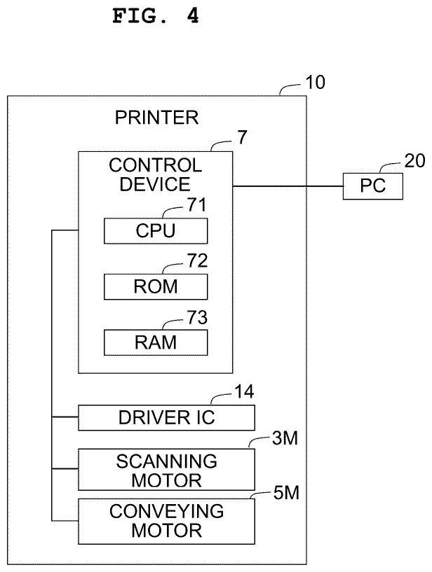

The scanning mechanism 3 includes a pair of guides 31 and 32 which support the carriage 2, and a belt 33 connected to the carriage 2. The guides 31 and 32 and the belt 33 extend in the scanning direction. In a case where a scanning motor 3M (see FIG. 4) is driven under the control of the control device 7, the belt 33 runs to thereby cause the carriage 2 and head 1 to move in the scanning direction along the guides 31 and 32. As a result, the head 1 moves in the scanning direction relative to the sheet 9 on the platen 4.

The platen 4 is disposed below the carriage 2 and the head 1. The sheet 9 is supported on the upper surface of the platen 4.

The conveying mechanism 5 includes an upstream roller 51 disposed upstream of the head 1 in the conveying direction, and a downstream roller 52 disposed downstream of the head 1 in the conveying direction. The head 1, the carriage 2, and the platen 4 are disposed between the upstream roller 51 and the downstream roller 52 in the conveying direction.

Each of the upstream roller 51 and the downstream roller 52 is constructed of one set of rotary members. The one set of rotary members includes an upper rotary member disposed above a conveyance route of the sheet 9 and a lower rotary member disposed below the conveyance route of the sheet 9. The upper rotary member and the lower rotary member are disposed so that circumferential surfaces of the upper rotary member and the lower rotary member are in contact with each other.

In a case where a conveying motor 5M (see FIG. 4) is driven under the control of the control device 7, the respective rotary members of the upstream roller 51 and the downstream roller 52 rotate. The respective rotary members of the upstream roller 51 and the downstream roller 52 rotate while holding the sheet 9, thereby conveying the sheet 9 in the conveying direction.

As depicted in FIG. 2, the head 1 includes a channel unit 12 and an actuator unit 13.

The plurality of nozzles 11 (see FIG. 1) is open in the lower surface of the channel unit 12. A common channel 12A and a plurality of individual channels 12B communicating with the common channel 12A are formed inside the channel unit 12. The common channel 12A communicates with an ink tank (not depicted in the drawings). Each of the plurality of individual channels 12B is an individual channel corresponding to one of the nozzles 11 and extending from an outlet of the common channel 12A through one of the plurality of pressure chamber 12P to the corresponding nozzle 11. The plurality of pressure chambers 12P is open in the upper surface of the channel unit 12. Each of the plurality of pressure chambers 12P is an example of a “channel”.

The actuator unit 13 includes; three piezoelectric layers 13A, 13B and 13C disposed on the upper surface of the channel unit 12 so as to cover the plurality of pressure chambers 12P; a low potential electrode 13D disposed on the upper surface of the piezoelectric layer 13A; a high potential electrode 13E disposed on the upper surface of the piezoelectric layer 13B; and a driving electrode 13F disposed on the upper surface of the piezoelectric layer 13C. The low potential electrode 13D and the high potential electrode 13E are disposed in common to the plurality of pressure chambers 12P. The driving electrode 13F is disposed with respect to each of the plurality of pressure chambers 12P.

The low potential electrode 13D, the high potential electrode 13E, and the driving electrode 13F are electrically connected to a driver IC 14 (see FIG. 4). The driver IC 14 is an example of a “driving circuit”. The driver IC 14 maintains the potential of the low potential electrode 13D at the ground potential (OV) and maintains the potential of the high potential electrode 13E at driving potential (VDD), while changing the potential of the driving electrode 13F between the ground potential (OV) and the driving potential (VDD). Specifically, the driver IC 14 generates a driving signal based on a control signal from the control device 7 and supplies the driving signal to the driving electrode 13F. This causes the potential of the driving electrode 13F to change between the driving potential (VDD) and the ground potential (OV).

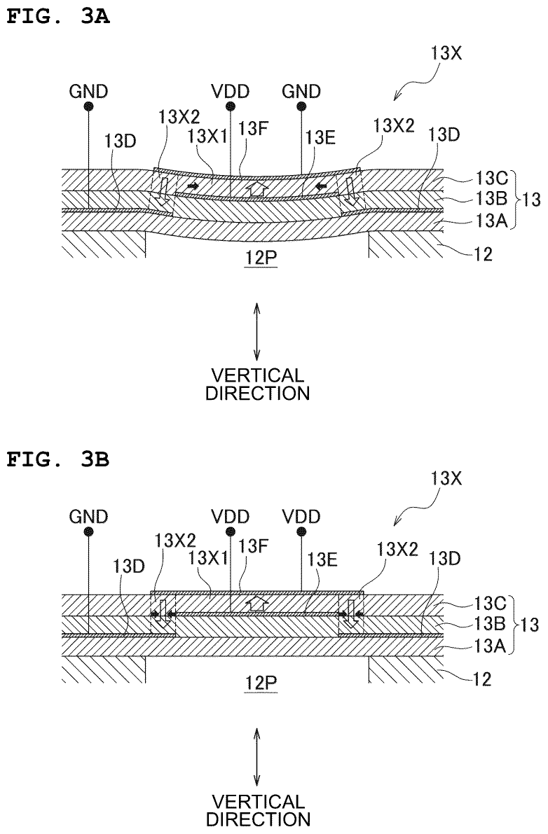

As depicted in FIG. 3A and FIG. 3B, a part, of the piezoelectric layer 13C, which is sandwiched between the driving electrode 13F and the high potential electrode 13E in the vertical direction is referred to as a first active part 13X 1. A part of the piezoelectric layer 13B and a part of the piezoelectric layer 13C which are sandwiched between the driving electrode 13F and the low potential electrode 13D in the vertical direction is referred to as a second active part 13X 2. The first active part 13X1 is polarized mainly upward, and the second active part 13X2 is polarized mainly downward. The actuator unit 13 has an actuator 13X constructed of one first active part 13X 1 and two second active parts 13X 2 with respect to each of the plurality of pressure chambers 12P.

In a case where the ground potential (OV) is applied to the driving electrode 13F, an electric field oriented upward, which is the same as the polarization direction of the first active part 13X1, is generated in the first active part 13X1 due to the potential difference between the driving electrode 13F and the high potential electrode 13E, and the first active part 13X1 contracts in a direction orthogonal to the vertical direction, as depicted in FIG. 3A. As a result, a stacked body constructed of the piezoelectric layers 13A, 13B and 13C is bent to project toward the pressure chamber 12P.

In a case where the potential of the driving electrode 13F is switched from the ground potential (OV) to the driving potential (VDD), the potential difference between the driving electrode 13F and the high potential electrode 13E disappears, and the contraction of the first active part 13X1 is released, as depicted in FIG. 3B. On the other hand, the potential difference between the driving electrode 13F and the low potential electrode 13D occurs, thereby generating an electric field oriented downward which is the same as the polarization direction of each of the second active parts 13X2 in each of the second active parts 13X2, thereby causing each of the second active parts 13X2 to contract in the direction orthogonal to the vertical direction. Note, however, that each of the second active parts 13X2 has a function of reducing the crosstalk, and hardly contributes to the deformation of the stacked body. Therefore, in this situation, the stacked body is not bent to project in a direction away from the pressure chamber 12P; rather, the stacked body becomes flat. As a result, the volume of the pressure chamber 12P increases, as compared to the state depicted in FIG. 3A.

Afterwards, in a case where the potential of the driving electrode 13F is switched from the driving potential (VDD) to the ground potential (OV), the potential difference between the driving electrode 13F and the low potential electrode 13D disappears, and the contraction of each of the second active parts 13X2 is released, as depicted in FIG. 3A. On the other hand, the potential difference between the driving electrode 13F and the high potential electrode 13E is generated, and the electric field oriented upward which is in the same direction as the polarization direction of the first active part 13X1 is thereby generated in the first active part 13X1, and the first active part 13X1 contracts in the direction orthogonal to the vertical direction. This causes the stacked body to bend to project toward the pressure chamber 12P. In this situation, the volume of the pressure chamber 12P decreases to thereby apply pressure to the ink in the pressure chamber 12P, and an ink droplet of the ink is ejected from the nozzle 11.

As described above, in the present embodiment, a “pull-strike system” is adopted, as a driving method of driving the actuator 13X, in which the volume of pressure chamber 12P is increased from a predetermined volume and then is decreased to the predetermined volume or less, thereby ejecting the ink droplet from the nozzle 11.

As depicted in FIG. 4, the control device 7 includes a CPU 71, a ROM 72, and a RAM 73. The ROM 72 stores a program and/or data with which the CPU 71 controls the various kinds of operations. The RAM 73 temporarily stores data to be used by the CPU 71 in a case where the CPU 71 executes the program. The CPU 71 executes a process in accordance with the programs and/or data stored in the ROM 72 and/or the RAM 73, based on data input from a PC 20. The CPU 71 is an example of a “controller”.

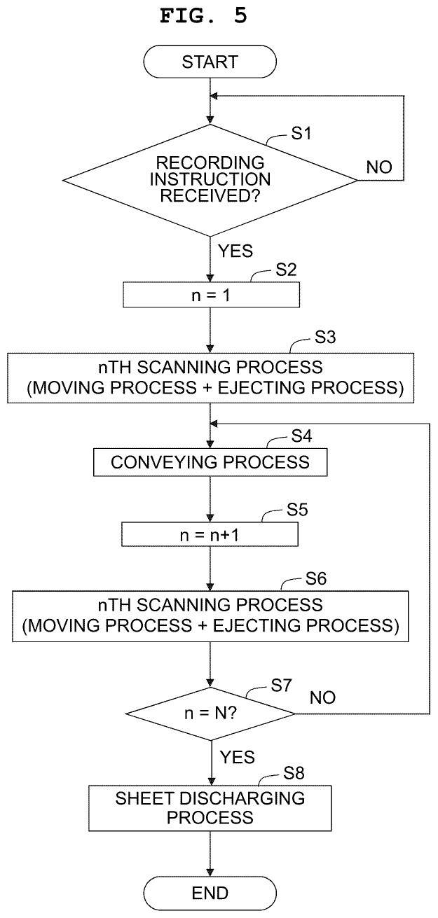

Next, the program executed by the CPU 71 will be described with reference to FIG. 5.

The CPU 71 first determines whether a recording instruction has been received from the PC 20 (step S1). In a case where the CPU 71 determines that the recording instruction has not been received (step S1: NO), the CPU 71 repeats the process of step S1.

In a case where the CPU 71 determines that the recording instruction has been received (step S1: YES), the CPU 71 sets n to 1 (n=1) (step S2).

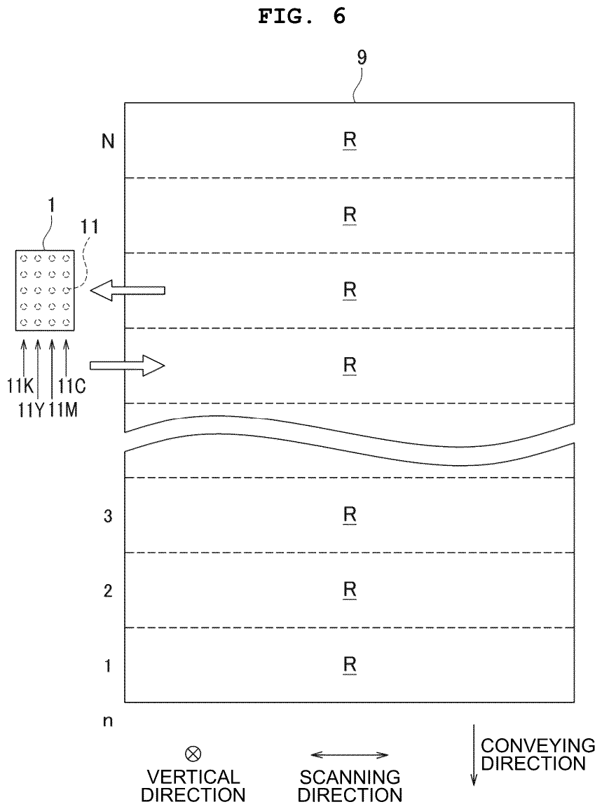

After step S2, the CPU 71 executes a n (=1)th scanning process based on the recording instruction (step S3). The scanning process includes a moving process of causing the scanning mechanism 3 to move the head 1 in the scanning direction, and an ejecting process of causing the driver IC 14 to supply the driving signal to the actuator 13X to thereby eject an ink droplet from the nozzle 11. During one time of the scanning process, the head 1 ejects an ink droplet with respect to a record area R of the sheet 9. The record area R is a partial area of the sheet P, and is a rectangular area extending in the scanning direction corresponding to one time of the scanning process (see FIG. 6).

After step S3, the CPU 71 executes a conveying process of causing the conveying mechanism 5 to convey the sheet 9 in the conveying direction by a predetermined amount (step S4).

After step S4, the CPU 71 sets n to n+1 (n=n+1) (step S5). That is, the CPU sets a value obtained by adding 1 to the “n” to be a new “n”.

After step S5, the CPU 71 executes the nth (n being in a range of 2 to N: n=2 to N) scanning process based on the recording instruction (step S6).

After step S6, the CPU 71 determines whether n=N holds (step S7).

In a case where the CPU 71 determines that n=N does not hold (step S7: NO), the CPU 71 returns the process to step S4. By executing such a procedure, the scanning process is sequentially performed for each of the plurality of record areas R (see FIG. 6) disposed side by side in the conveying direction in the sheet 9.

In a case where the CPU 71 determines that n=N holds (step S7: YES), the CPU 71 executes a sheet discharging process of causing the conveying mechanism 5 to convey the sheet 9 to a sheet discharge tray (not depicted in the drawings) of the printer 10 (step S8), and ends the program.

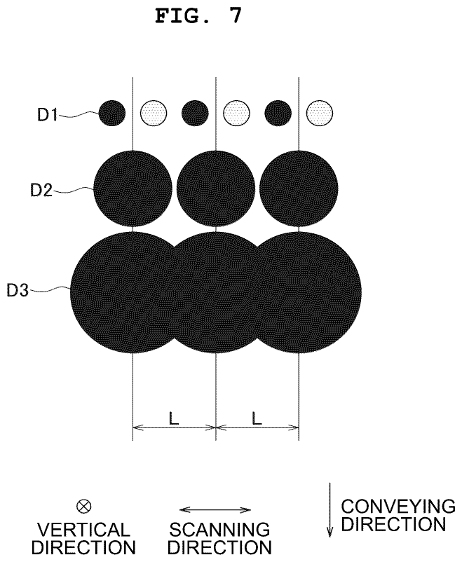

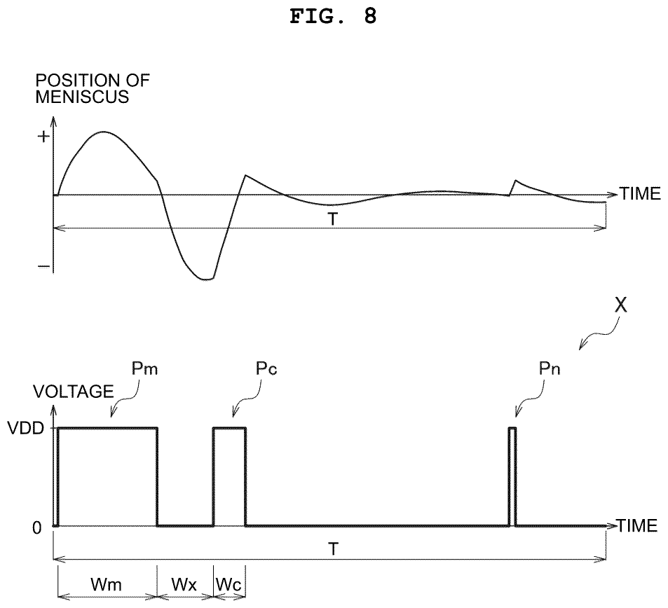

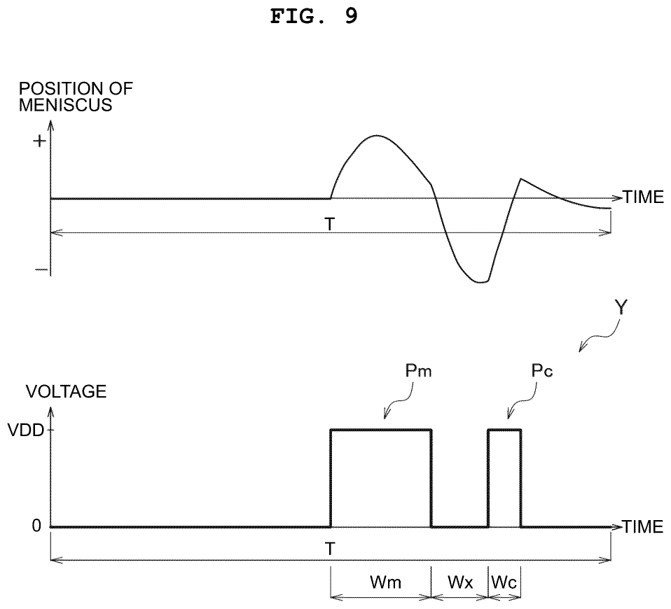

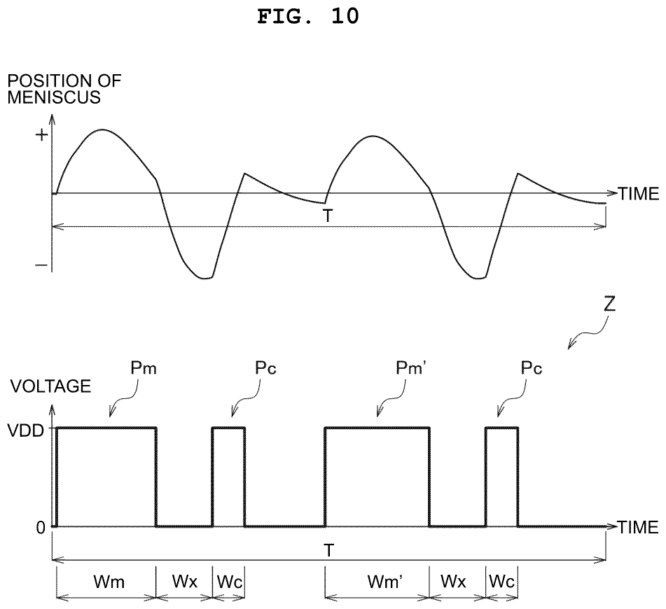

Next, the driving signal supplied to the actuator 13X in the ejecting process will be described, with reference to FIGS. 7 to 10.

As depicted in FIG. 7, the driving signal includes a driving signal for small droplet configured to cause the actuator 13X to eject a small droplet D1, a driving signal for medium droplet configured to cause the actuator 13X to eject a medium droplet D2, and a driving signal for large droplet configured to cause the actuator 13X to eject a large droplet D3. The small droplet D1, the medium droplet D2, and the large droplet D3 are ink droplets, and have volumes different from each other. The volume of the small droplet D1 is smaller than the volume of the medium droplet D2, and the volume of the medium droplet D2 is smaller than the volume of the large droplet D3. The driving signal further includes a non-ejection signal configured to cause the actuator 13X to eject no ink droplet.

Regarding each of the medium droplet D2 and the large droplet D3, one droplet is ejected at a reference timing in each recording cycle T corresponding to a unit distance L. Regarding the small droplet D1, the case where one droplet is ejected at a first timing before the reference timing in each recording cycle T (see a solid dot), the case where one droplet is ejected at a second timing after the reference timing in each recording cycle T (see a hatched dot), and the case where two droplets in total are ejected at both the first timing and the second timing in each recording cycle T (see the solid dot and the hatched dot) exist.

The driving signal for small droplet includes a first waveform signal X (see FIG. 8) configured to cause the actuator 13X to eject the small droplet D1 at the first timing, a second waveform signal Y (see FIG. 9) configured to cause the actuator 13X to eject the small droplet D1 at the second timing, and a third waveform signal Z (see FIG. 10) configured to cause the actuator 13X to eject the small droplet D1 at both the first timing and the second timing.

Each of the medium droplet D2 and the large droplet D3 is an example of a “droplet of first volume”. The small droplet D1 is an example of a “droplet of second volume”. Each of the driving signal for medium droplet and the driving signal for large droplet is an example of a “first driving signal”. The driving signal for small droplet is an example of a “second driving signal”.

In the ejecting process based on one recording instruction, the CPU 71 causes the driver IC 14 to supply, to the actuator 13X, a driving signal selected from the above-described driving signals based on the image data included in the recording instruction, for each recording cycle T. The recording cycle T is a time to move the head 1 relative to the sheet 9 by the unit distance L.

Further, in a case where the CPU 71 causes the driver IC 14 to supply the driving signal for small droplet to the actuator 13X in the ejecting process based on the one recording instruction, the CPU 17 causes the driver IC 14 to supply, to the actuator 13X, one of the first waveform signal X, the second waveform signal Y, or the third waveform signal Z as the driving signal for small droplet. Each of the first waveform signal X, the second waveform signal Y, and the third waveform signal Z is an example of a “second driving signal”.

As the driving signal for small droplet, the first waveform signal X configured to cause the actuator 13X to eject the small droplet D1 at the first timing, the second waveform signal Y configured to cause the actuator 13X to eject the small droplet D1 at the second timing, and the third waveform signal Z configured to cause the actuator 13X to eject the small droplet D1 at both the first timing and the second timing are selectively used, so that the resolution in the scanning direction of the small droplet D1 can be twice the resolution in the scanning direction of the medium droplet D2 or the large droplet D3. That is, in this case, the resolution in the scanning direction of the driving signal for small droplet is higher than the resolution in the scanning direction of the driving signal for medium droplet or the driving signal for large droplet. For example, in a head with a nozzle pitch of 300 dpi in the scanning direction, only the small droplet D1 can achieve a resolution of 600 dpi in the scanning direction.

As depicted in FIG. 8 and FIG. 9, each of the first waveform signal X and the second waveform signal Y includes, within one recording cycle T, a main pulse wave Pm for ejecting an ink droplet, and a cancel pulse wave Pc applied after the main pulse wave Pm and for canceling the pressure wave in the pressure chamber 12P generated by the application of the main pulse wave Pm. A width Wc of the cancel pulse wave Pc is smaller than a width Wm of the main pulse wave Pm.

Between the first waveform signal X and the second waveform signal Y, the widths Wm of the main pulse waves Pm are the same as each other, the widths Wc of the cancel pulse waves Pc are the same as each other, and times Wx each from the falling point of time of the main pulse wave Pm to the rising point of time of the cancel pulse wave Pc are also the same as each other. That is, the width of at least one timing in which the voltage is changed due to the pulse wave in the first waveform signal X is the same as the width of at least one timing in which the voltage is changed due to the pulse wave in the second waveform signal Y.

The first waveform signal X further includes an additional pulse wave Pn applied after the cancel pulse wave Pc, as depicted in FIG. 8. The width of the additional pulse wave Pn is smaller than the width Wc of the cancel pulse wave Pc. The additional pulse wave Pn amplifies the residual vibration in the pressure chamber 12P.

The main pulse wave Pm is an example of a “first pulse wave”, and the additional pulse wave Pn is an example of a “second pulse wave”.

As depicted in FIG. 10, the third waveform signal Z includes, within one recording cycle T, two main pulse waves Pm and Pm′, and two cancel pulse waves PC which are applied after the main pulse waves Pm and Pm′, respectively.

In the third waveform signal Z, a width Wm of the main pulse wave Pm relating to the ejection at the first timing and a width Wc of each of the cancel pulse waves Pc relating to the ejection at the first timing and the second timing are respectively the same as the width Wm and the width Wc in each of the first waveform signal X and the second waveform signal Y. In the third waveform signal Z, a width Wm′ of the main pulse wave Pm′ relating to the ejection at the second timing is greater than the width Wm. A time Wx from the falling point of time of each of the main pulse waves Pm and Pm′ to the rising point of time of the cancel pulse wave Pc is the same as the time Wx in each of the first waveform signal X and second waveform signal Y.

The third waveform signal Z (see FIG. 10) is obtained by synthesizing the first waveform signal X (see FIG. 8) and the second waveform signal Y (see FIG. 9), but at least a part of the pulse waves constructing the first waveform signal X, at least a part of the pulse waves constructing the second waveform signal Y and at least a part of the pulse waves constructing the third waveform signal Z are mutually different. Specifically, the main pulse wave Pm′ of the third waveform signal Z has the width which is different from the width of the main pulse wave Pm of the second waveform signal Y. Further, the third waveform signal Z does not include the additional pulse wave Pn included in the first waveform signal X. Thus, at least a part of the pulse wave of the third waveform signal Z is different from the pulse wave obtained by synthesizing the pulse wave of the first waveform signal X and the pulse wave of the second waveform signal Y.

In each of the first to third waveform signals X, Y and Z, at the starting point of time of the recording cycle T, the potential of the driving electrode 13F is the ground potential (OV). In this situation, the stacked body of the piezoelectric layers 13A, 13B and 13C is bent to protrude toward the pressure chamber 12P (see FIG. 3A). In a case where the potential of the driving electrode 13F is switched from the ground potential (OV) to the driving potential (VDD) at the rising point of time of the main pulse wave Pm, the stacked body becomes flat and the volume of the pressure chamber 12P increases (see FIG. 3B). In this situation, the ink is sucked from the common channel 12A to the individual channel 12B. Then, in a case where the potential of the driving electrode 13F is switched from the driving potential (VDD) to the ground potential (OV) at the falling point of time of the main pulse wave Pm, the stacked body bends to protrude toward the pressure chamber 12P (see FIG. 3A). This increases the pressure of the ink due to the decrease in the volume of the pressure chamber 12P, thereby ejecting an ink droplet from the nozzle 11.

The upper diagram of each of FIG. 8 to FIG. 10 depicts a change in the position of the meniscus formed in the nozzle 11 due to the change in the potential of the driving electrode 13F. The vertical axis of each of FIGS. 8 to 10 depicts the position of the meniscus, with the positive side being the side moving upward from the nozzle 11 and the negative side being the side moving downward from the nozzle 11.

As appreciated from FIGS. 8 to 10, the meniscus retreats toward the pressure chamber 12P with the application of the main pulse wave Pm or the main pulse wave Pm′; then, with the fall of the main pulse wave Pm or the main pulse wave Pm′, the meniscus protrudes downward from the nozzle 11 and flies as an ink droplet. Further, with the application of the cancel pulse wave Pc, the meniscus retreats toward the pressure chamber 12P, so that the ink droplet flown in response to the application of the main pulse wave Pm or the main pulse wave Pm′ is separated from the meniscus.

After the application of the cancel pulse wave Pc, the meniscus gradually moves downward. In the first waveform signal X (see FIG. 8), the additional pulse wave Pn is further applied after the cancel pulse wave Pc has been applied, and the residual vibration in the pressure chamber 12P is amplified, so that the meniscus retreats again toward the pressure chamber 12P. After the application of the additional pulse wave Pn, the meniscus gradually moves downward. As a result, the positions of the meniscuses at the end of the recording cycle T are substantially the same as each other among the first waveform signal X, the second waveform signal Y, and the third waveform signal Z.

As described above, according to the present embodiment, in the ejecting process based on one recording instruction (see FIG. 7), the CPU 71 causes the driver IC 14 to selectively supply, to the actuator 13X, the driving signal for medium droplet, the driving signal for large droplet, and the driving signal for small droplet in which the resolution is higher than the resolution in each of the driving signal for medium droplet and the driving signal for large droplet. In this case, since the moving speed of the carriage 2 is not slowed down for the purpose of increasing the resolution, the high-speed recording can be realized. Further, by using the driving signal for small droplet, the high resolution of recording can be realized. Furthermore, by selectively using the driving signal for medium droplet and the driving signal for large droplet by each of which the resolution is low and the driving signal for small droplet by which the resolution is high in the ejecting process based on one recording instruction, the improved gradation can be realized.

The volume of the ink droplet (small droplet D1) corresponding to a driving signal of high-resolution is smaller than the volume of the ink droplet (medium droplet D2 or large droplet D3) corresponding to a driving signal of low-resolution. In this case, the image quality is improved by causing the small droplet D1 to have the high resolution.

Among the driving signals for small droplet, the first waveform signal X (see FIG. 8) includes the main pulse wave Pm by which the ink droplet is ejected at the first timing, and the additional pulse wave Pn by which the residual vibration in the pressure chamber 12P is amplified after the application of the main pulse wave Pm. As a result, the residual vibrations in the pressure chamber 12P at the end of the recording cycle T are the same as each other between a case where the ink droplet is ejected at the first timing by the first waveform signal X (see FIG. 8) and in a case where the ink droplet is ejected at the second timing by the second waveform signal Y (see FIG. 9). Therefore, regardless of which one of the first waveform signal X and the second waveform signal Y is selected, the pressures in the pressure chamber 12P at the point of time when the application of a next driving signal is started becomes equivalent to each other between the case where the first waveform signal X is selected and the case where the second waveform signal Y is selected, and continuous ejection can be realized stably.

The widths of at least one timing in which the voltage is changed due to the pulse wave are the same as each other between the first waveform signal X and the second waveform signal Y (see FIG. 8 and FIG. 9). With this, the volumes and the flying speeds of the ink droplets can be made the same as each other between the case where the ink droplet is ejected at the first timing by the first waveform signal X (see FIG. 8) and the case where the ink droplet is ejected at the second timing by the second waveform signal Y (see FIG. 9).

At least a part of the pulse wave of the third waveform signal Z (see FIG. 10) is different from the pulse wave obtained by synthesizing the pulse wave of the first waveform signal X (see FIG. 8) and the pulse wave of the second waveform signal Y (see FIG. 9). In this manner, by not making the pulse wave of the third waveform signal Z (see FIG. 10) a waveform obtained by simply synthesizing the pulse wave of the first waveform signal X (see FIG. 8) and the pulse wave of the second waveform signal Y (see FIG. 9), the positions of the meniscuses at the end of the recording cycle T can be made substantially the same as each other among the first waveform signal X, the second waveform signal Y, and the third waveform signal Z. As a result, continuous ejection can be stably performed.

The head 1 has the nozzles 11 which eject the ink droplets of the four colors, which are cyan, magenta, yellow and black (see FIG. 1). By using the driving signal for small droplets in each of the four colors, the gradation of each of the four colors is improved.

### (Modification)

While the invention has been described in conjunction with various example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiments of the disclosure, as set forth above, are intended to be illustrative of the invention, and not limiting the invention. Various changes may be made without departing from the spirit and scope of the disclosure. Therefore, the disclosure is intended to embrace all known or later developed alternatives, modifications, variations, improvements, and/or substantial equivalents. Some specific examples of potential alternatives, modifications, or variations in the described invention are provided below:

For example, although the resolution of the driving signal for small droplet is higher than the resolution of the driving signal for medium droplet or the resolution of the driving signal for large droplet in the above-described embodiment, the resolution of the driving signal for medium droplet or the resolution of the driving signal for large droplet may be higher than the resolution of the driving signal for small droplet.

Although the head ejects the liquids of the plurality of colors in the above-described embodiment, the head may be configured to eject only a liquid of one color, for example, a black ink.

The type of the head is not limited to the serial type, and may be a line type. In a case where the type of the head is the line type, the conveying mechanism 5 is an example of a “mover” which may move the head and the recording medium relative to each other along the conveying direction.

The droplet ejecting apparatus may include a plurality of heads.

The recording medium is not limited to the sheet, and may be, for example, cloth, a substrate, a plastic member, etc.

In the above-described embodiment, the actuator has the three-layered structure including the driving electrode to which the high potential and the low potential are selectively applied, the high potential electrode which is held at the high potential, and the low potential electrode which is held at the low potential. The present disclosure, however, is not limited to this. For example, the actuator may have a two-layered structure including a driving electrode to which a high potential and a low potential are selectively applied, and a low potential electrode which is held at the low potential.

The liquid ejected from the nozzle is not limited to the ink, and may be any liquid (for example, a treatment liquid which agglutinates or precipitate a component of an ink, etc.).

The present disclosure is not limited to being applicable to the printer, and may be applicable also to a facsimile, a copying machine, a multi-function peripheral, etc. The present disclosure is applicable also to a droplet ejecting apparatus used in an application other than the recording of image (e.g., a droplet ejecting apparatus which ejects droplets of a conductive liquid onto a substrate to form a conductive pattern).

The program according to the present disclosure may be distributed in a state that the program is recorded on a removable storage medium such as a flexible disc, etc., or a fixed storage medium such as a hard disk, etc.; or may be distributed via a communication line.

What is claimed is:

1. A droplet ejecting apparatus comprising:
a head having a nozzle, a channel communicating with the nozzle, and an actuator configured to apply pressure to a liquid in the channel;
a driving circuit configured to supply a driving signal to the actuator;
a mover configured to move the head and a recording medium relative to each other along a moving direction; and
a controller, wherein:
the controller is configured to execute a moving process of causing the mover to move the head and the recording medium relative to each other, and an ejecting process of causing the driving circuit to supply the driving signal to the actuator to cause the actuator to eject a droplet of the liquid from the nozzle;
the driving signal includes a first driving signal configured to cause the actuator to eject the droplet of a first volume, and a second driving signal configured to cause the actuator to eject the droplet of a second volume different from the first volume, a resolution in the moving direction of the second driving signal being higher than a resolution in the moving direction of the first driving signal; and
the controller is configured to, in the ejecting process based on one recording instruction, cause the driving circuit to selectively supply the first driving signal or the second driving signal to the actuator.

2. The droplet ejecting apparatus according to claim 1, wherein the second volume is smaller than the first volume.

3. The droplet ejecting apparatus according to claim 1, wherein:
the second driving signal includes a first waveform signal configured to cause the actuator to eject the droplet at a first timing, and a second waveform signal configured to cause the actuator to eject the droplet at a second timing later than the first timing;
the controller is configured to, in a case where the controller causes the driving circuit to supply the second driving signal to the actuator in the ejecting process based on the one recording instruction, cause the driving circuit to supply one of the first waveform signal or the second waveform signal as the second driving signal; and
the first waveform signal includes a first pulse wave configured to cause the actuator to eject the droplet at the first timing, and a second pulse wave configured to amplify residual vibration in the channel after the first pulse wave.

4. The droplet ejecting apparatus according to claim 1, wherein:
the second driving signal includes a first waveform signal configured to cause the actuator to eject the droplet at a first timing, and a second waveform signal configured to cause the actuator to eject the droplet at a second timing later than the first timing;
the controller is configured to, in a case where the controller causes the driving circuit to supply the second driving signal to the actuator in the ejecting process based on the one recording instruction, cause the driving circuit to supply one of the first waveform signal or the second waveform signal as the second driving signal;
each of the first waveform signal and the second waveform signal includes one pulse wave or a plurality of pulse waves; and
a width of at least one voltage changed timing by the one pulse wave or the plurality of pulse waves of the first waveform signal and a width of at least one voltage changed timing by the one pulse wave or the plurality of pulse waves of the second waveform signal are same as each other.

5. The droplet ejecting apparatus according to claim 1, wherein:
the second driving signal includes a first waveform signal configured to cause the actuator to eject the droplet at a first timing, a second waveform signal configured to cause the actuator to eject the droplet at a second timing later than the first timing, and a third waveform signal configured to cause the actuator to eject the droplet at both the first timing and the second timing;
the controller is configured to, in a case where the controller causes the driving circuit to supply the second driving signal to the actuator in the ejecting process based on the one recording instruction, cause the driving circuit to supply one of the first waveform signal, the second waveform signal or the third waveform signal as the second driving signal; and
at least a part of a pulse wave of the third waveform signal is different from a pulse wave obtained by synthesizing a pulse wave of the first waveform signal and a pulse wave of the second waveform signal.

6. The droplet ejecting apparatus according to claim 1, wherein:
the channel includes a first channel configured to flow a liquid of a first color, and a second channel configured to flow a liquid of a second color different from the first color; and
the nozzle includes a first nozzle communicating with the first channel, and a second nozzle communicating with the second channel.

7. A control method of a droplet ejecting apparatus, the droplet ejecting apparatus including:
a head having a nozzle, a channel communicating with the nozzle, and an actuator configured to apply pressure to a liquid in the channel;
a driving circuit configured to supply a driving signal to the actuator; and
a mover configured to move the head and a recording medium relative to each other along a moving direction,
the control method comprising:
causing the mover to move the head and the recording medium relative to each other; and
causing the driving circuit to supply the driving signal to the actuator to cause the actuator to eject a droplet of the liquid from the nozzle,
wherein the driving signal includes a first driving signal configured to cause the actuator to eject the droplet of a first volume, and a second driving signal configured to cause the actuator to eject the droplet of a second volume different from the first volume, a resolution in the moving direction of the second driving signal being higher than a resolution in the moving direction of the first driving signal,
the control method comprising, in causing the driving circuit to supply the driving signal to the actuator based on one recording instruction, causing the driving circuit to selectively supply the first driving signal or the second driving signal to the actuator.

8. A non-transitory and computer-readable medium storing a program executable by a controller for a droplet ejecting apparatus, the droplet ejecting apparatus including:
a head having a nozzle, a channel communicating with the nozzle, and an actuator configured to apply pressure to a liquid in the channel;
a driving circuit configured to supply a driving signal to the actuator; and
a mover configured to move the head and a recording medium relative to each other along a moving direction, wherein:
the program is configured to cause the controller to execute:
causing the mover to move the head and the recording medium relative to each other; and
causing the driving circuit to supply the driving signal to the actuator to cause the actuator to eject a droplet of the liquid from the nozzle;
the driving signal includes a first driving signal configured to cause the actuator to eject the droplet of a first volume, and a second driving signal configured to cause the actuator to eject the droplet of a second volume different from the first volume, a resolution in the moving direction of the second driving signal being higher than a resolution in the moving direction of the first driving signal; and
the program is configured to cause the controller to, in causing the driving circuit to supply the driving signal to the actuator based on one recording instruction, cause the driving circuit to selectively supply the first driving signal or the second driving signal to the actuator.
